(19) United States
(12) Patent Application Publication
(10) Pub. No.: US 2005/0286767 A1
(43) Pub. Date: Dec. 29, 2005

(54) System and method for 3D object recognition using range and intensity

(76) Inventors: Gregory D. Hager, Baltimore, MD (US); Eliot Leonard Wegbreit, Palo Alto, CA (US)

Correspondence Address: CARR & FERRELL LLP, 2200 GENG ROAD, PALO ALTO, CA, 94303, US

(21) Appl. No.: 11/159,660

(22) Filed: Jun. 22, 2005

Related U.S. Application Data
(60) Provisional application No. 60/582,461, filed on Jun. 23, 2004.

(51) Int. Cl. G06K 9/46; G06K 9/00

(52) U.S. Cl. 382/190; 382/154

(57) ABSTRACT

A system and method for performing object and class recognition that allows for wide changes of viewpoint and distance of objects is disclosed. The invention provides for choosing pose-invariant interest points of a three-dimensional (3D) image, and for computing pose-invariant feature descriptors of the image. The system and method also allows for the construction of three-dimensional (3D) object and class models from the pose-invariant interest points and feature descriptors of previously obtained scenes. Interest points and feature descriptors of a newly acquired scene may be compared to the object and/or class models to identify the presence of an object or member of the class in the new scene.

### CROSS-REFERENCE TO RELATED APPLICATIONS

This application claims the benefit of U.S. Provisional Patent Application Ser. No. 60/582,461, filed Jun. 23, 2004, entitled “A system for 3D Object Recognition Using Range and Appearance,” which is incorporated herein by reference in its entirety.

### BACKGROUND OF THE INVENTION

1. Field of the Invention

The present invention relates generally to the field of computer vision and, in particular, to recognizing objects and instances of visual classes.

2. Description of the Prior Art

Generally speaking, the object recognition problem is to determine which, if any, of a set of known objects is present in an image of a scene observed by a video camera system. The first step in object recognition is to build a database of known objects. Information used to build the database may come from controlled observation of known objects, or it may come from an aggregation of objects observed in scenes without formal supervision. The second step in object recognition is to a match a new observation of a previously viewed object with its representation in the database.

The difficulties with object recognition are manifold, but generally relate to the fact that objects may appear very differently when viewed from a different perspective, in a different context, or under different lighting. More specifically, three categories of problems can be identified: (1) difficulties related to changes in object orientation and position relative to the observing camera (collectively referred to as “pose”); (2) difficulties related to change in object appearance due to lighting (“photometry”); and (3) difficulties related to the fact that other objects may intercede and obscure portions of known objects (“occlusion”).

Class recognition is concerned with recognizing instances of a class, to determine which, if any, of a set of known object classes is present in a scene. A general object class may be defined in many ways. For example, if it is defined by function then the general class of chairs contains both rocking chairs and club chairs. When a general class contains objects that are visually dissimilar, it is convenient to divide it into sub-classes so that the objects in each are visually similar. Such a subclass is called a “visual object class.” General class recognition is then done by visual class recognition of the sub-class, followed by semantic association to find the general class containing the sub-class. In the case of chairs, an instance of a rocking chair might be recognized based on its visual characteristics, and then database lookup might find the higher-level class of chair. A key part of this activity is visual class recognition.

The first step in visual class recognition is to build a database of known visual classes. As with objects, information used to build the database may come from controlled observation of designated objects or it may come from an aggregation, over time, of objects observed in scenes without formal supervision. The second step in visual class recognition is to match new observations with their visual classes as represented in the database. It is convenient to adopt the shorthand “object class” in place of the longer “visual object class.” Subsequent discussion will use “object class” with this specific meaning.

Class recognition has the problems of object recognition, plus an additional category: difficulties related to within-class or intra-class variation. The instances of a class may vary in certain aspects of their shape or their visual appearance. A class recognizer must be able to deal with this additional variability.

Hithertofore, there have been no entirely satisfactory solution to these problems. Substantial research has been devoted to object and class recognizers, but there are none that can recognize a very wide variety of objects or classes from a wide variety of viewpoints and distances.

Prior Work in Object Recognition

It is convenient to discuss the work in object recognition first. This work can be divided into two basic approaches: geometry-based approaches and appearance-based approaches. Broadly speaking, geometry-based approaches rely on matching the geometric structure of an object. Appearance-based approaches rely on using the intensity values of one or more spectral bands in the camera image; this may be grey-scale, color, or other image values.

Geometry-based approaches recognize objects by recording aspects of three-dimensional geometry of the object in question. Grimson, Object Recognition by Computer: The Role of Geometric Constraints, MIT Press 1990, describes one such system. Another system of this type is described in Johnson and Hebert, “Using Spin Images for Efficient Object Recognition in Cluttered 3D Scenes”, IEEE Transactions on Pattern Analysis and machine Intelligence, Vol. 21, No5. pp 433-448. Another such system is described in Frome et al, “Recognizing Objects in Range Data Using Regional Point Descriptors”, Proceedings of the European Conference on Computer Vision, May 2004, pp 224-237. These systems rely on the fact that certain aspects of object geometry do not change with changes in object pose. Examples of these aspects include the distance between vertices of the object, the angles between faces of an object, or the distribution of surface points about some distinguished point. Geometry-based approaches are insensitive to pose by their choice of representation and they are insensitive to photometry because they do not use intensity information.

The main limitation of these systems is due to the fact that they do not utilize intensity information, i.e., they do not represent the difference between objects that have similar shape, but differing appearance in the intensity image. For example, many objects in a grocery store have similar size and shape (e.g., cans of soup), and only differ in the details of their outward appearance. Furthermore, many common objects that have simple geometric form, such as cylinders, rectangular prisms or spheres, do not provide sufficiently unique or, in some cases, well-defined geometric features to work from.

One group of appearance-based approaches uses the 2D intensity image of the entire object to be recognized or a large portion thereof. There are many variations on the approach. Some of the more important variations are described in the following papers: Turk and Pentland, ‘Eigenfaces for Recognition’. Journal of Cognitive Neuroscience, 1991, 3 (1), pp 71-86; Murase and Nayar, “Visual Learning and Recognition of 3-D Objects from Appearance”, International Journal of Computer Vision, 1995, 14, pp 5-24; and Belhumeur, et al, “Eigenfaces vs. Fisherfaces: Recognition Using Class Specific Linear Projection”, IEEE Transactions on Pattern Analysis and Machine Intelligence, 1997, 19(7), pp 711-720.

This group of approaches has several difficulties. Images of an object can change greatly based on the pose of the object and the lighting of the scene, so many images are, in principle, necessary. A more fundamental limitation is that the approach assumes that the object to be recognized has already been isolated (“segmented”) from the video image by other means, but segmentation is often difficult, if not impossible. Finally, a further limitation arises from the fact that if a significant portion of the object becomes occluded, the recorded images will no longer match.

Another group of approaches uses local, rather than global, intensity image features. These methods take advantage of the fact that small areas of the object surface are less prone to occlusion and are less sensitive to illumination changes. There are many variations on the method. In general terms, the method consists of the following steps: detecting significant local regions, constructing descriptors for these local regions, and using these local regions in matching.

Most of these methods build a database of object models from 2D images and recognize acquired scenes as 2D images. There are many papers using this approach. Representative papers include the following: Schmid and Mohr “Local Grayvalue Invariants for Image Retrieval”, IEEE Transactions on Pattern Recognition and Machine Intelligence, 19, 5 (1997) pp 530-534; Mikolajczyk and Schmid, “An affine invariant interest point detector”, European Conference on Compute Vision 2002 (ECCV), pp. 128-142; Lowe, “Object recognition from local scale-invariant features”, International Conference on Computer Vision, 1999 (ICCV), pp. 1150-1157; and Lowe “Distinctive Image Features from Scale-Invariant Keypoints, accepted for publication in the International Journal of Computer Vision, 2004. Patents in this area include Lowe, U.S. Pat. No. 6,711,293.

A variant of this technique builds a 3D database of object models from 2D images and recognizes acquired scenes as 2D images. This approach is described in Rothganger et al, “3D Object Modeling and Recognition Using Local Affine-Invariant Patches and Multi-View Spatial Constraints”, Conference on Computer Vision and Pattern Recognition, (CVPR 2003), pp 272-277, and Rothganger, et al, “3D Object Modeling and Recognition Using Local Affine-Invariant Image Descriptors and Multi-View Spatial Constraints”, International Journal of Computer Vision, 2005.

While local features are less sensitive to changes in illumination and occlusion, they are still sensitive to changes in the geometric relationship between the camera and the viewed surface. That is, a small patch of a surface when viewed head-on looks very different from when the same patch is viewed obliquely. Likewise, a surface feature viewed at a small distance looks different when viewed from a large distance. Thus, the principle difficulty in feature-based object recognition is to find a representation of local features that is insensitive to changes in distance and viewing direction so that objects may be accurately detected from many points of view. Currently available methods do not have a practical means for creating such feature representations. Several of the above methods provide limited allowance for viewpoint change; however, the ambiguity inherent in a 2D image means that in general it is not possible to achieve viewpoint invariance.

A third approach to object recognition combines 3D and 2D images in the context of face recognition. A survey of this work is given in Bowyer et al, “A Survey of approaches to Three-Dimensional Face Recognition”, International Conference on Pattern Recognition, (ICPR), 2004, pp 358-361. This group of techniques is generally referred to as “multi-modal.” In the work surveyed, the multi-modal approach uses variations of a common technique, which is that a 3D geometry recognition result and a 2D intensity recognition result are each produced without reference to the other modality, and then the recognition results are combined by some voting mechanism. Hence, the information about the 3D location of intensity data is not available for use in recognition. In particular, the 2D intensity image used in 2D recognition is not invariant to change of pose.

Prior Work in Class Recognition

Prior work in class recognition has been along lines similar to object recognition and suffers from related difficulties.

One line of research represents a class as an unordered set of parts. Each part is represented by a model for the local appearance of that part, generalized over all instances of the class. The spatial relationship of the parts is ignored. One paper taking this approach is Dorko and Schmid, “Selection of Scale-Invariant Parts for Object Class Recognition”, ICCV 2003, pp. 634-640. A later paper by the same authors, expanding on this approach, is “Object Class Recognition Using Discriminative Local Features” submitted to IEEE Transactions on Pattern Analysis and Machine Intelligence. In this work, training data is acquired from 2D images. The appearance of each part in a class is represented by a Gaussian mixture model obtained from the intensity appearance of the part in the various training images. There are several difficulties with this general approach. The most important limitation is that since the geometric relationship of the parts is not represented, considerable important information is lost. An object with its parts jumbled into random locations will be recognized just as well as the object itself.

Another line of research represents a class as a constellation of parts with 2D structure. Each part is represented by a model for the local intensity appearance of that part, generalized over all instances of the class, while the geometric relationship of the parts is represented by a model in which spatial location is generalized over all instances of the class. Two papers applying this approach are Burl et al, “A probabilistic approach to object recognition using local photometry and global geometry”, Proc. European Conference on Computer Vision (ECCV) 1998, pp 628-641, and Fergus et al, “Object Class Recognition by Unsupervised Scale-Invariant Learning”, Computer Vision and Pattern Recognition, 2003, pp 264-271. Another paper along these lines is Helmer and Lowe, “Object Class Recognition with Many Local Features”, IEEE Computer Vision and Pattern Recognition Workshops, 2004 (CVPRW'04), pp. 187 ff.

The appearance of the parts and their geometric relationship is the result of generalizing from a set of 2D images of class instances. A generalized class instance is represented by a set of Gaussian functions for the appearance of parts and for their relationship in a 2D generalized image. There are two difficulties with this approach. First, the local appearance of parts is not pose invariant. Second, the relationship of the parts is acquired and modeled only as the parts occur in 2D images; the underlying 3D spatial relationship is not observed, computed, nor modeled. Consequently, the range of viewpoints is limited.

Hence, there is a need for a system and method able to perform object and class recognition over wide changes in distance and viewing direction, and one that is able to utilize the advantages and abilities of both the 2D and 3D methods of the prior art.

### SUMMARY

The present invention provides a system and method for performing object and class recognition that allows for wide changes of viewpoint and distance of objects. This is accomplished by combining various aspects of the 2D and 3D methods of the prior art in a novel fashion.

The present invention provides a system and method for choosing pose-invariant interest points of a three-dimensional (3D) image, and for computing pose-invariant feature descriptors of the image. The system and method also allows for the construction of three-dimensional (3D) object and class models from the pose-invariant interest points and feature descriptors of previously obtained scenes. Interest points and feature descriptors of a newly acquired scene may be compared to the object and/or class models to identify the presence of an object or member of the class in the new scene.

For example, in one embodiment the present invention discloses a method for recognizing objects in an observed scene, comprising the steps of: acquiring a three-dimensional (3D) image of the scene; choosing pose-invariant interest points in the image; computing pose-invariant feature descriptors of the image at the interest points, each feature descriptor comprising a function of the local intensity component of the 3D image as it would appear if it were viewed in a standard pose with respect to a camera; constructing a database comprising 3D object models, each object model comprising a set of pose-invariant feature descriptors of one or more images of an object; and comparing the pose-invariant feature descriptors of the scene image to pose-invariant feature descriptors of the object models. Embodiments of the system and the other methods, and possible alternatives and variations, are also disclosed.

The present invention also provides a computer-readable medium comprising program instructions for performing the steps of the various methods.

### BRIEF DESCRIPTION OF DRAWINGS

In the attached drawings:

FIG. 1 is a symbolic diagram showing the principal elements of a system for acquiring a 3D description of a scene according to an embodiment of the invention;

FIG. 2 is a symbolic diagram showing the principal steps of constructing a pose-invariant feature descriptor according to an embodiment of this invention;

FIG. 3 is a symbolic diagram showing the principal elements of a system for database construction according to an embodiment of the invention;

FIG. 4 is a symbolic diagram showing the principal components of a system for recognition according to an embodiment of the invention;

FIG. 5 is a symbolic diagram showing the primary steps of recognition according to an embodiment of the method of the invention; and

FIG. 6 illustrates the effects of frontal transformation according to an embodiment of the invention.

### DETAILED DESCRIPTION

The present invention performs object and class recognition that is robust with respect to changes in viewpoint and distance by using images containing both three-dimensional (3D) and intensity appearance information. This is accomplished by obtaining both about range and intensity images of a scene, and combining the information contained in those images in a novel fashion to describe the scene so that it may be used for recognition of objects in the scene and identification of those objects as belonging to a class. Unless otherwise stated, “recognition” shall include both object recognition and class recognition.

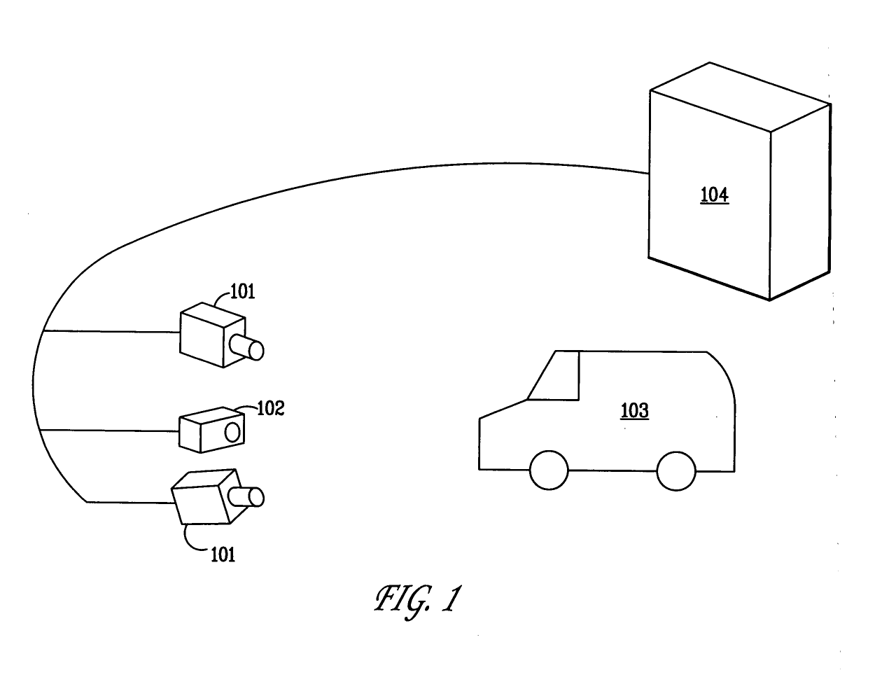

FIG. 1 is a symbolic diagram showing the principal physical components of a system for acquiring a 3D description of a scene configured in accordance with an embodiment of the invention. A set of two or more cameras 101 and a projector of patterned light 102 are used to acquire images of an object 103. A computer 104 is used to compute the 3D position of points in the image using stereo correspondence. A preferred embodiment of the stereo system is disclosed in U.S. patent application Ser. No. 10/703,831, filed Nov. 7, 2003, which is incorporated herein by reference.

The 3D description is referred to as a “range image”. This range image is placed into correspondence with the intensity image to produce a “registered range and intensity image”, sometimes referred to as the “registered image” and sometimes as a “3D image”. In this registered image, each image location has one or more intensity values, and a corresponding 3D coordinate giving its location in space relative to the observing stereo ranging system. The set of intensity values are referred to as the “intensity component” of the 3D image. The set of 3D coordinates are referred to as the “range component” of the 3D image.

To explain the operation of the invention it is useful to consider how changes in object pose affect the appearance of local features. There are six possible changes to the pose of an object:
Two of these are changes parallel to the camera-imaging plane;
One is a rotation about the optical axis of the camera;
One is a change in the distance between the camera and the object;
Two are changes in the slant and tilt of the surface relative to observing camera.

Changes in the position of the object parallel to the camera imaging plane only cause changes in the position of a feature in an image and therefore do not affect its appearance if a correction is made for the location of the feature in the image plane. Rotation of the object about the optical axis of the camera leads to rotation of the feature in the image. There are many methods for locating and representing features that are not affected by rotation, so this motion is also easily accounted for.

The present invention alleviates the difficulties presented by the remaining three changes—in distance, slant, and tilt. It does so by combining the image intensity of the observed object with simultaneously computed range information to compute pose-invariant feature representations. In particular, by knowing the distance to the feature point, it is possible to remove the effect of scale change. From the range information, the local surface normal can be computed and, using this, it is possible to remove the effects of slant and tilt. As a result, it is possible to compute local features that are insensitive to all possible changes in the pose of the object relative to the observing camera. Since the features are local, they can be made insensitive to photometric effects. Since there are many local features, their aggregate is insensitive to occlusion so long as several are visible.

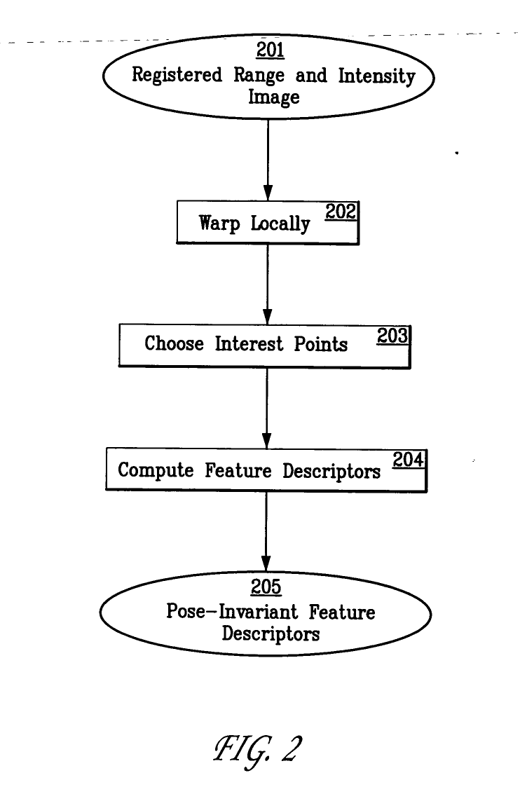

FIG. 2 is a symbolic diagram showing the principal steps of a method of constructing a pose-invariant feature descriptor according to an embodiment of this invention. A registered range and intensity image is given as input at step 201. The image is locally transformed at step 202 to a standard pose with respect to the camera, producing a set of transformed images. This transformation is possible because the image contains both range and intensity information. Interest points on the transformed image are chosen at step 203. At each interest point, a feature descriptor is computed in step 204. The feature descriptor includes a function of the local image intensity about the interest point. Additionally, the feature descriptor may also include a function of the local surface geometry about the interest point. The result is a set of pose-invariant feature descriptors 205. This method is explained in detail below, as are various embodiments and elaborations of these steps. Alternatively, it is possible to combine steps; for example, one may incorporate the local transformation into interest point detection, or into the computation of feature descriptors, or into both. This is entirely equivalent to a transformation step followed by interest point detection or feature descriptor computation.

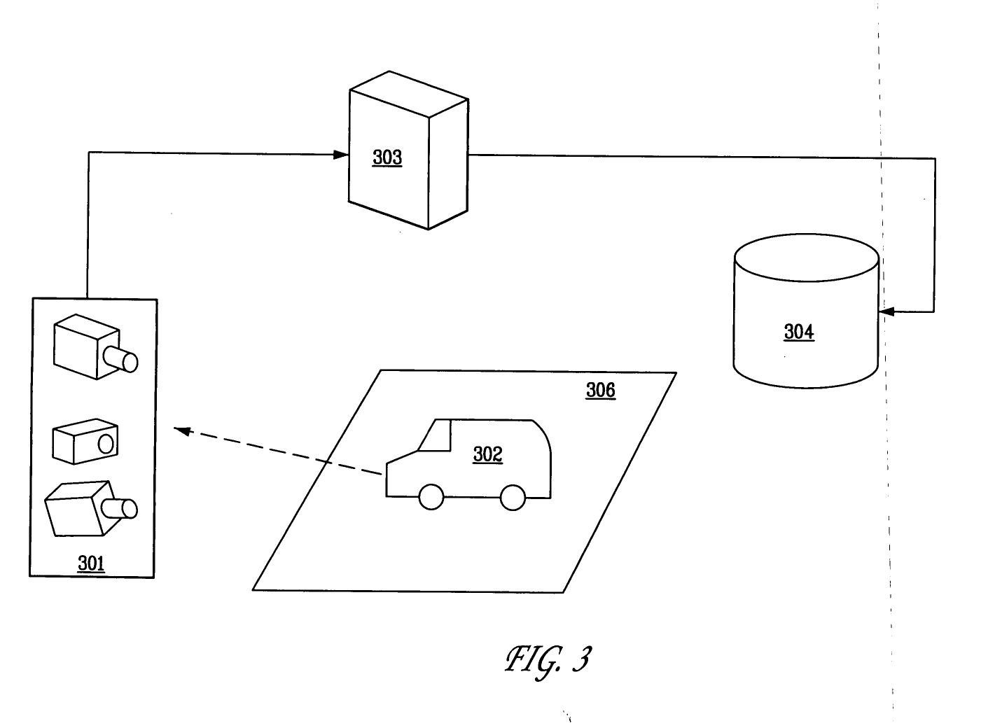

In general terms, recognition using these pose-invariant features has two parts: database construction and recognition per se. FIG. 3 is a symbolic diagram showing the principal components of database construction according to an embodiment of the invention. An imaging system 301 acquires registered images of objects 302 on a horizontal planar surface 306 at a known height. A computer 303 builds object models or class models and stores them in a database 304.

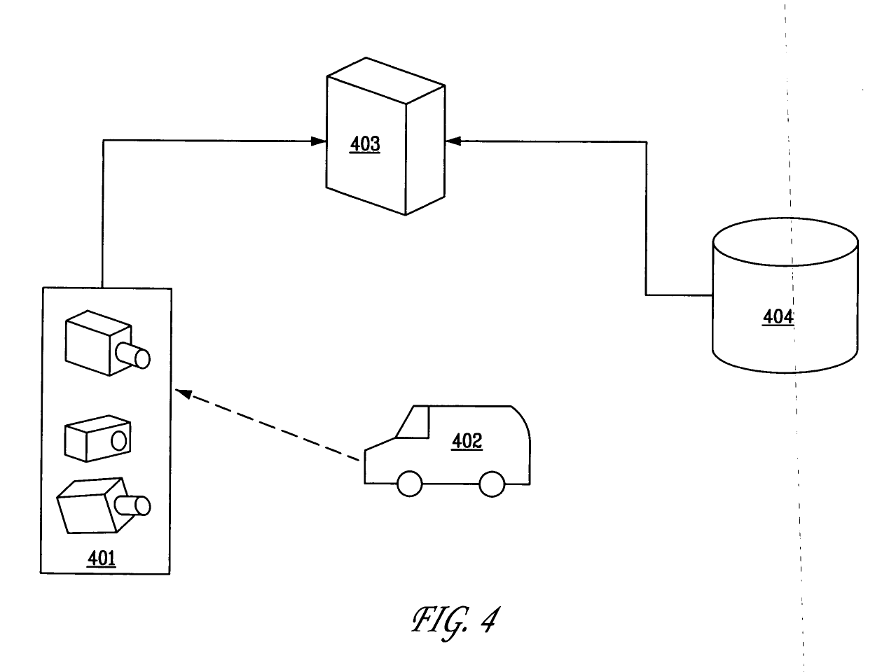

FIG. 4 is a symbolic diagram showing the principal components of a recognition system according to an embodiment of this invention. An imaging system 401 acquires registered images of a scene 402 and a computer 403 uses the database 404 to recognize objects or instances of object classes in the scene. The database 404 of FIG. 4 is the database 304 shown as being constructed in FIG. 3.

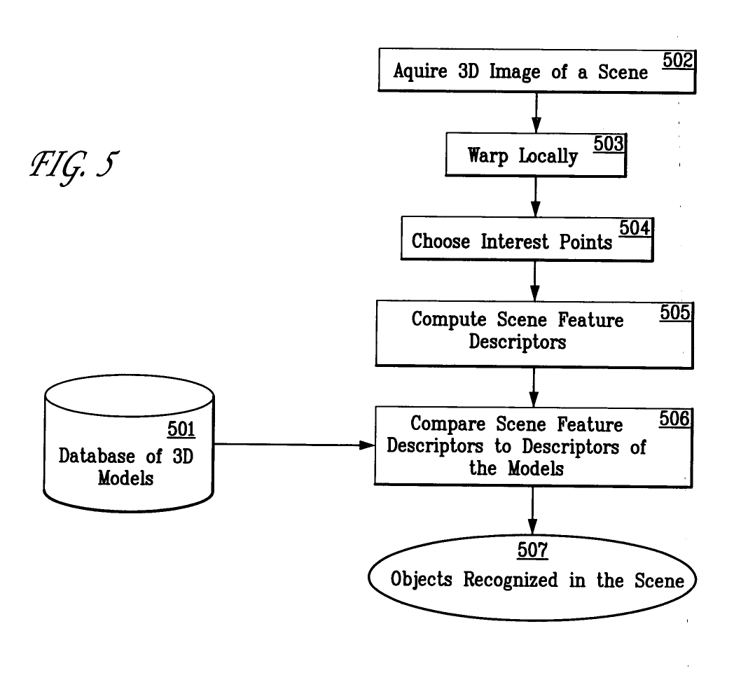

FIG. 5 is a symbolic diagram showing the primary steps of recognition according to an embodiment of the invention. At step 501, a database is constructed containing 3D models, each model comprising a set of descriptors. In the case of object recognition, the models are object models and the descriptors are pose-invariant feature descriptors; in the case of class recognition, the models are class models and the descriptors are class descriptors. A registered range and intensity image is acquired at step 502. The image is locally transformed in step 503 to a standard pose with respect to the camera, producing a set of transformed images. Interest points on the transformed images are chosen at step 504. Pose-invariant feature descriptors are computed at the interest points in step 505. Pose-invariant feature descriptors of the observed scene are compared to descriptors of the object models at step 506. In step 507, a set of objects identified in the scene is identified.

A system or method utilizing the present invention is able to detect and represent features in a pose-invariant manner; this ability is conferred to both flat and curved objects. An additional property is the use of both range and intensity information to detect and represent said features.

### BACKGROUND

In order to understand subsequent descriptions, it is useful to review a few basic definitions and facts about digital range and intensity images. First, at every location in an image, it is possible to compute approximations to spatial derivatives of the image intensity. This is commonly performed by computing the convolution of the image with a convolution kernel that is a discrete sampling of the derivative of a Gaussian function centered at the point in question. The derivatives can be computed along both the columns and rows of the images (the “x” and “y” directions), in which case the combined result is known as the image gradient at that point.

These approximations can be computed with Gaussian functions (“Gaussians”) that have a different spread, controlled by using the variance parameter of the Gaussian function. The spread of a Gaussian function is referred to as the “scale” of the operator, and roughly corresponds to choosing a level of detail at which the afore-mentioned image information is computed.

Given a neighborhood of pixels, it is possible to first compute the image gradient for each pixel location, and then to compute a 2 by 2 matrix consisting of the sum of the outer product of each gradient vector with itself, divided by the number of pixels in the region. This is a symmetric positive semidefinite matrix, which is referred to as the “gradient covariance matrix.” Since it is 2 by 2 and symmetric, it has two real non-negative eigenvalues with associated eigenvectors. The eigenvector associated with the largest eigenvalue is referred to as the “dominant gradient direction” for that neighborhood. The ratio of the smallest eigenvalue to the largest eigenvalue is referred to as the “eigenvalue ratio.” The eigenvalue ratio ranges between 0 and 1, and is an indicator of how much one gradient direction dominates the others in the region.

The present invention also uses a range image that is registered to the intensity image. As noted above, the fact that the range image is registered to the intensity image means that each location in the intensity image has a corresponding 3D location. It is important to realize that these 3D locations are relative to the camera viewing location, so a change in viewing location will cause both the intensity image and the range image of an object to change. However, given two range images, the points that are visible in both views can be related by a single change of coordinates consisting of a translation vector and a rotation matrix. In the case that the translation and rotation between views is known, the points in the two images can be merged and/or compared with each other. The process of computing the translation and rotation between views, thus placing points in those two views in a common coordinate system, is referred to as “aligning” the views.

All of the preceding concepts can be found in standard undergraduate textbooks on digital signal processing or computer vision.

Locally Warping Images

The present invention makes use of range information to aid in the location and description of regions of an image that are indicative of an object or class of objects. Such regions are referred to as “features.” The algorithm that locates features in an image is referred to as an “interest operator.” An interest operator is said to be “pose-invariant” if the detection of features is insensitive to a large range of changes in object pose.

Once detected, a feature is represented in a manner that facilitates matching against features detected in other range and intensity images. The representation of a feature is referred to as a “feature descriptor.” A feature descriptor is said to be “pose-invariant” if the descriptor is insensitive to a large range of changes in object pose.

The present invention achieves this result in part by using information in the range image to produce new images of surfaces as viewed from a standard pose with respect to the camera. In the first and second embodiments, the standard pose is chosen so that the camera axis is aligned with the surface normal at each feature and the surface appears as it would when imaged at a fixed nominal distance. Such an alignment is said to be “frontal normal”.

To describe this process, it is useful to consider a point at location T on an observed surface. If the surface is smooth at this point, there is an associated normal vector n, and two values tₓ and t_{y} with associated directions eₓ and e_{y} so that the form of the surface can be locally described as
z=(tₓx²+t_{y}y²)/2
where the z coordinate is in the direction of n, and x and y lie along eₓ and e_{y}, respectively. A portion of a surface modeled in this form is referred to as a “surface patch.” The values of tₓ and t_{y} do not depend on the position or orientation of the observed surface.

For a given image location, the values of tₓ and t_{y} with associated directions eₓ and e_{y} can be computed or approximated in a number of ways from range images. In one embodiment, smooth connected surfaces are extracted from the range data by first choosing a set of locations, known as seed locations, and subsequently fitting analytic surfaces to the range image in neighborhoods about these seed locations. For seed locations where the surface fits well, the size of the neighborhood is increased, whereas neighborhoods where the surface fits poorly are reduced or removed entirely. This process is iterated until all areas of the range image are described by some analytic surface patch. Methods for computing quadric surfaces from range data are well-established in the computer vision literature and can be found in a variety of references, e.g., Petitjean, “A survey of methods for recovering quadrics in triangle meshes”, ACM Computing Surveys, Vol. 34, No. 2, June 2002, pp. 211-262. Methods for iterative segmentation of range images are well established and can be found in a variety of references, e.g., A. Leonardis et al., “Segmentation of range images as the search for geometric parametric models”, International Journal of Computer Vision, 1995, 14, pp 253-277.

The values eₓ, e_{y}, and n together form a rotation matrix, R, that transforms points from patch coordinates x, y, and z to the coordinate system of the range image. The center of the patch, T, specifies the spatial position. The pair X=(T, R) thus defines the pose of the surface patch relative to the observing system.

It is now possible to produce a new intensity image of the area of the surface as if it were viewed along the surface normal at a nominal distance d. To do so, consider a set of sampling locations
qᵢ=(xᵢ,yᵢ, (tₓxᵢ²+t_{y}yᵢ²)/2)^{T}, for i=1, 2 . . . N
preferably arranged in a grid. Compute pᵢ=R qᵢ+T. The values pᵢ are now locations on the object surface in the coordinate system of original range and intensity images.

The image locations corresponding to the points pᵢ can now be computed using standard models of perspective projection, yielding image locations uᵢ, i=1, 2 . . . N. The value of the intensity or range image at this image location can now be sampled, preferably using bilinear interpolation of neighboring values. These samples now constitute the intensity image and geometry of the surface for sample locations (xᵢ, yᵢ), i=1, 2 . . . N, corresponding to an orthographic camera looking directly along the surface normal direction.

By construction, the area of the surface represented in a patch is invariant to changes in object pose, and thus the appearance of features on the object surface are likewise invariant up to the sample spacing of the camera system. The sample spacing of the locations (xᵢ, yᵢ) may be chosen to approximate the view of a camera with pixel spacing s and focal length f at distance d by choosing spacing s*=s (d/f). In the first and second embodiments, s=0.0045 mm/pixel, d=1000 mm, and f=12.5 mm. Thus s*=0.36 mm/pixel.

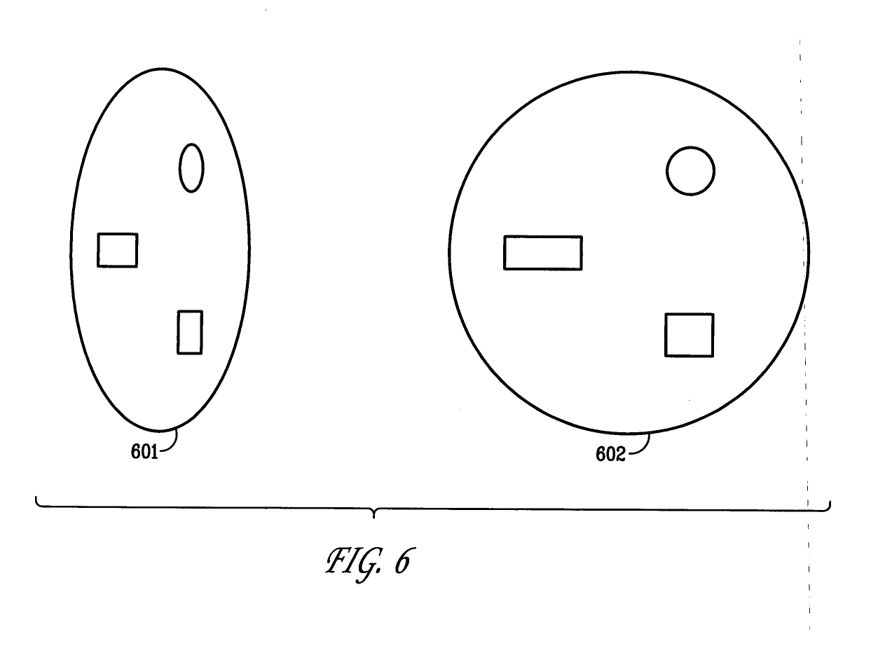

FIG. 6 shows the result of frontal warping. 601 is a surface shown tilted away from the camera axis by a significant angle, while 602 is the corresponding surface transformed to be frontal normal.

Detecting Pose-Invariant Interest Points

A combined range and intensity image containing several objects may be segmented into a collection of smaller areas that may be modeled as quadric patches, each of which is transformed to appear in a canonical frontal pose. Additionally, the size of each patch may be restricted to ensure a limited range of surface normal directions within the patch.

More specifically, patches are chosen such that no surface normal at any sample point in the patch makes an angle larger than θₘₐₓ with n. This implies that the range of x and y values within the local coordinate system of the patch fall within an elliptical region defined by a value λ such that:
tₓ²x²+t_{y}²y²≦sec(θₘₐₓ)²−1=λ²
Thus, a patch will have the desired range of surface normals if |x|≧xₘₐₓ=λ/tₓ and |y|≦yₘₐₓ=λ/t_{y}. An image patch with this property will be referred to as a “restricted viewing angle patch.” The values xₘₐₓ and yₘₐₓ are used to determine the number of sampling locations needed to completely sample a restricted viewing angle patch. In the x direction, the number will be 2*xₘₐₓ/s* and in y it will be 2*yₘₐₓ/s*.

In the first and second embodiments described below, the value of θₘₐₓ is chosen to be 20 degrees, although other embodiments may use other values of θₘₐₓ.

Surface patches that do not satisfy the restricted viewing angle property are subdivided into smaller patches until they are restricted viewing angle patches, or a minimal patch size is reached. When dividing a patch, the new patches are chosen to overlap at their boundaries to ensure that no image locations (and hence interest points) fall directly on, or directly adjacent to, a patch boundary in all patches. Patches are divided by choosing the coordinate direction (x or y) over which the range of normal directions is the largest, and creating two patches equally divided in this coordinate direction.

The restricted viewing angle patches are warped as described above, where the warping is performed on the intensity image. Interest points are located on the warped patches by executing the following steps:

1. Compute the eigenvalues of the gradient image covariance matrix at every pixel location and for several scales of the aforementioned gradient operator. Let mine and maxE denote the minimum and maximum eigenvalues so computed, and let r denote their eigenvalue ratio.

2. Compute a list L1 of potential interest points by finding all locations where mine is maximal in the image at some scale.

3. Remove from L1 all locations where the ratio r is less than a specified threshold. In the first and second embodiments, the threshold is 0.2, although other embodiments may use other values. 4. For each element of L1, compute the tuple <P, L, S, E, X> where P is the patch, L is the 2D location of the interest point on the patch, S is the scale, E is the eigenvalue ratio, and X is the 3D pose of the interest point. The list of such tuples over all patches is a set of interest points in the intensity image. These are locations in the image where the intensity appearance has distinctive structure.

The same process is applied to the range image: The range image is warped to be frontal normal. In place of the intensity at a given (x, y) location, the range value z in local patch coordinates is used to compute the gradient covariance matrix at each pixel. The other steps are similar. The result is a list of interest points based on the range image. These are locations in the image where the surface geometry has distinctive structure.

This process is repeated for other types of interest point detectors operating on intensity and range images. Several interest point detectors are described in K. Mikolajczyk et al., “A Comparison of Affine Region Detectors”, to appear in International Journal of Computer Vision. For each interest point, there is a label K indicating the type of interest point detector used to locate it.

The techniques described above ensure that the interest point detection process locates very nearly the same set of interest points at the same locations when the object is viewed over a large range of surface orientations and positions.

Representing Pose-Invariant Features

Next, the local appearance at each interest point is computed. Let <P, L, S, E, X> be an interest point. As the surface normal of the interest point may deviate from that of the patch upon which it is detected, a rotation matrix R_{L} is recomputed specifically for the interest point location L.

When computing this rotation matrix, the ratio of surface curvatures, min(tₓ, t_{y})/max(tₓ, t_{y}) is compared to E. If E is larger than the surface curvature ratio, the rotation matrix R_{L} is computed from eₓ, e_{y}, and n as described previously. Otherwise the rotation matrix R is computed from the eigenvectors of E and the surface normal n as follows. A zero is appended to the end of both of the eigenvectors of E. These vectors are then multiplied by the rotation matrix R originally computed when the patch was frontally warped. This produces two orthogonal vectors iₓ and i_{y} that represent the dominant intensity gradient direction in the coordinate system of the original range image. The final rotation matrix R_{L} is then created from iₓ, i_{y} and n. In either case, X is now defined as X=(T, R_{L}).

A fixed size area about L in the restricted viewing angle patch P is now warped using X, producing a new local area P′, so that P′ now appears to be viewed frontally centered. The corresponding range information associated with the area about L in patch P is similarly warped, producing a canonical local range image D′. In the first and second embodiments, a patch size of 1 cm by 1 cm is used (creating an image patch of size 28 pixels by 28 pixels) although other embodiments may use other patch sizes.

P′ is normalized by subtracting its mean intensity, and dividing by the square root of the sum of the squares of the resulting intensity values. Thus, changes in brightness and contrast do not affect the appearance of P′. A feature descriptor is constructed that includes a geometric descriptor X=(T, R_{L}), an appearance descriptor A =(P′, D′), and a qualitative descriptor Q=(κ, S, tₓ, t_{y}, E). The geometric descriptor specifies the location of a feature; the appearance descriptor specifies the local appearance; and the qualitative descriptor is a summary of the salient aspects of the local appearance.

Frontal warping ensures that the locations of the features and their appearance have been corrected for distance, slant, and tilt. Hence, the features are pose invariant and are referred to as “pose-invariant features”. Additionally, their construction makes them invariant to changes in brightness and contrast.

Recognition Using Pose-Invariant Features—Background

An object model O is a collection of pose-invariant feature descriptors expressed in a common geometric coordinate system. Let F be the collection of pose-invariant feature descriptors observed in the scene. Define the “object likelihood ratio” as
L(F,O)=P(F|O)/P(F|˜O)
where P(F|O) is the probability of the feature descriptors F given that the object is present in the scene and P(F|˜O) is the probability of the feature descriptors F given that the object is not present in the scene. The object O is considered to be present in the scene if L(F, O) is greater than a threshold τ. The threshold τ is empirically determined for each object as follows. Several independent images of the object in normally occurring scenes are acquired. For several values of τ, the number of times the object is incorrectly recognized as present when it is not (false positives) and the number of times the object is incorrectly stated as not present when it is (false negatives) is tabulated. The value of τ is taken as that for which the value at which the number of false positives equals the number of false negatives.

In order to evaluate the numerator of this expression, it is useful to introduce a mapping hypothesis h to describe a match between observed features and model features, and a relative pose χ between the model object coordinate system and the observed feature coordinate system. The equation then becomes:

$$L ( F , O ) = ( {\sum }_{h} \int χ P ( F \vert O , h , χ ) P ( h \vert O , χ ) P ( χ \vert O ) ) / P ( F \vert \sim O )$$

As the goal is to exceed the threshold τ, the system will attempt to maximize L over all candidate model objects O. However, the number of hypotheses h over which to evaluate this expression is enormous. In order to improve the computational aspects of the method, the first and second embodiments rely on the fact that, in most cases, the correct match h should be unique, and this match should completely determine the pose χ. Under these assumptions, an approximation to the above equation is given by:
L(F,O)≈max_{χ}maxₕP(F|O,h,χ)P(h|O,χ)P(χ|O)/P(F|˜O)
If the result of this expression exceeds τ, then the object O is deemed present. The value of the pose χ that maximizes this expression specifies the position and orientation of the object in the scene.

Elements of the object likelihood ratio can be further refined. Recall that each feature is composed of an appearance descriptor, a qualitative descriptor, and a geometric descriptor. Let F_{A} denote the appearance descriptors of a set of observed features. Let O_{A} denote the appearance descriptors of a model object O. Likewise, let Fₓ and Oₓ denote the corresponding observed and model geometric descriptors, and let F_{Q} and O_{Q} denote the corresponding observed and model qualitative descriptors. Given a mapping h between a set of observed features and a set of model features, F_{A}(k) is the appearance descriptor of the kth feature in the set and O_{A}(h(k)) is the appearance descriptor in the corresponding feature of the model. Similarly, Fₓ(k) is the geometric descriptor of the kth feature of the set and Oₓ(h(k), χ) is the geometric descriptor of the corresponding feature of the model when the model is in the pose χ.

Feature geometry descriptors are conditionally independent given h and χ. Also, each feature's appearance descriptor is approximately independent of other features. Hence,
P(F|O,h,χ)/P(F|˜O)=⊂ₖL_{A}(F,O,h,k)L_{X}(F,O,h,χ,k)
where
L_{A}(F,O,h,k)=P(F_{A}(k)|O_{A}(h(k)))/P(F_{A}(k)|˜O)
and
L_{X}(F,O,h,χ,k)=P(Fₓ(k)|Oₓ(h(k),χ)/P(Fₓ(k)|˜O)

L_{A} is subsequently referred to as the “appearance likelihood ratio” and L_{X} as the “geometry likelihood ratio.” The numerators of these expressions are referred to as the “appearance likelihood function” and the “geometry likelihood function,” respectively.

The denominator of L_{A} can be approximated by observing that the set of detected features in the object database provides an empirical model for the set of all features that might be detected in images. A feature is highly distinctive if it differs from all other features on all other objects. For such features, L_{A} is large. Conversely, a feature is not distinctive if it occurs generically on several objects. For such features, L_{A} is close to 1. As a result, an effective approximation to P(F_{A}(k)|˜O) is:
P(F_{A}(k)|˜O)≈max_{O′≠O}max_{jεO},P(F_{A}(k)|O′_{A}(j))

The denominator of Lₓ, P(Fₓ(k)|˜O), represents the probability of a feature being detected at a given image location when the object O is not present. This value is approximated as the ratio of the average number of features detected in an image to the number of places at which interest points can be detected. When interest point detection is localized to image pixels, the number of places is simply the number of pixels.

L(F,O) contains two additional terms, P(h|O, χ) and P(χ|O). The latter is the probability of an object appearing in a specific pose. In the first and second embodiments, this is taken to be a uniform distribution.

P(h|O, χ) is the probability of the hypothesis h given that the object O is in a given pose χ. It can be viewed as a “discount factor” for missing matches. That is, for a given pose χ of object O, there is a set of/features that are potentially visible. If every expected (based on visibility) feature on the object were observed, P(h|O, χ) would be maximal; fewer matches should result in a lower value. After performing the visibility computation, the first embodiment expects some number N of features to be visible. P(h|O, χ) is then approximated using a binomial distribution with parameters N and detection probability p. The latter is determined empirically based on the properties of the interest operator used to detect features.

The first and second embodiments make use of the fact that the likelihoods introduced above may be evaluated more efficiently by taking their natural logarithms.

The likelihood functions described above may take many forms. The first and second embodiments assume additive noise in the measurements and thus the probability value P(f|m) for an observed feature value f and matched model feature m is P(f−m). If both f and m are normally distributed with covariances Λ_{f} and Λₘ, the logarithm of this probability is −½(f−m)^{T}(Λ_{f}+Λₘ)⁻¹(f−m), plus terms that do not depend on f or m. In the first and second embodiments, Λ_{f} is empirically determined for several different feature distances and slant and tilt angles. Features observed at a larger distance and at higher angles have correspondingly larger values in Λ_{f} than those observed at a smaller distance and frontally. The value of Λₘ is determined as the object model is acquired.

Subsequently disclosed aspects of the invention apply and/or make further refinements to the object likelihood ratio, the appearance likelihood ratio, the qualitative likelihood ratio, the geometry likelihood ratio, and the methods of probability calculation described above.

Two possible embodiments of this invention are now described. A first embodiment deals with object recognition. A second embodiment deals with class recognition. There are many possible variations on each of these and some of these variations are described in the section on Alternative Embodiments.

### First Embodiment

The first embodiment is concerned with recognizing objects. This first embodiment is described in two parts: (1) database construction and (2) recognition.

Database Construction

FIG. 3 is a symbolic diagram showing the principal components of database construction. For each object to be recognized, several views of the object are obtained under controlled conditions. The scene contains a single foreground object 302 on a horizontal planar surface 306 at a known height. The background is a simple collection of planar surfaces of known pose with uniform color and texture. An imaging system 301 acquires registered range and intensity images.

For each view of the object, registered range and intensity images are acquired, frontally warped patches are computed, interest points are located, and a feature descriptor is computed for each interest point. In this way, each view of an object has associated with it a set of features of the form <X, Q, A> where X is the 3D pose of the feature, Q denotes the qualitative descriptor, and A is the appearance descriptor. The views are taken under controlled conditions, so that each view also has a pose expressed relative to a fixed base coordinate system associated with it.

The process of placing points in two or more views into a common coordinate system is referred to as “aligning” the views. During database construction, views are aligned as follows. Since the pose of each view is known, an initial transformation aligning the observed pose-invariant features in the two images is also known. Once aligned, a match hypothesis h is easily generated by matching each pose-invariant feature to its nearest neighbor, provided that neighbor is sufficiently close. Thus, initial estimates for both h and the pose χ needed to compute the object likelihood ratio L(F,O) are easily computed.

Due to physical process errors, there may be some error in the pose so that the alignment is not exact, merely very close. This may also lead to errors or ambiguities in h. In order to deal with these errors, only pose-invariant features with a large appearance and geometry likelihood ratio are first considered in h. A final alignment step is performed by computing the closed form solution to the least-squares problem of absolute orientation using these pose-invariant features. This is used to refine the 3D location of each feature and the process is repeated until convergence.

An object model is thus built up by starting the model as one view and processing others with reference to it. In general, a model has one or more segments. For each new view of the object, there are four possible results of alignment:

(1) The object likelihood ratio is large and there are no unmatched pose-invariant features in the new view. In this case, the view adds no substantial new information. This occurs when the viewpoint is subsumed by viewpoints already accounted for by the model. In this case, the information in corresponding pose-invariant features descriptors is averaged to reduce noise.

(2) The view aligns with a single segment and contains new information. This occurs when the viewpoint is partly novel and partly shared with views already accounted for in that segment. In this case, the new features are added to the segment description. Matching pose-invariant feature descriptors are averaged to reduce noise.

(3) The view aligns with two or more segments. This occurs when the viewpoint is partly novel and partly shared with viewpoints already accounted for in the database entry for that object. In this case, the segments are geometrically aligned and merged into one unified representation. Matching pose-invariant feature descriptors are averaged to reduce noise.

(4) The view does not match. This occurs when the viewpoint is entirely novel and shares nothing with viewpoints of the database entry for that object. In this case, a new segment description is created and initialized with the observed features.

In the typical case, sufficient views of an object are obtained that the several segments are aligned and merged, resulting in a single, integrated model of the object.

When database construction is complete, information stored in the database consists of a set of object models, where each object model has associated with it a set of features, each of the form <X, Q, A> where X is the 3D pose of the feature expressed in an object-centered geometric reference system, Q is the list of qualitative descriptors, and A is the appearance descriptor. Each quantity also has an associated covariance matrix that is estimated from the deviation of the original measurements from the averaged descriptor value.

Recognition

FIG. 4 is a symbolic diagram showing the principal components of a recognition system. Unlike database creation; scenes are acquired under uncontrolled conditions. A scene may contain none, one, or more than one known object. If an object is present, it may be present once or more than once. An object may be partially occluded and may be in contact with other objects. The goal of recognition is to locate known objects in the scene.

The first step of recognition is to find smooth connected surfaces as described previously. The next step is to process each surface to identify interest points and extract a set of scene features as described above. Each feature has the form F=<X, Q, A> where X is the 3D pose of the feature, Q is the qualitative descriptor, and A is the appearance descriptor.

Object recognition is accomplished by matching scene features with model features, and evaluating the resulting match using the object likelihood ratio. The first step in this process is to locate plausible matches in the model features for each scene feature. For each scene feature, the qualitative descriptor is used to look up only those model features with qualitative descriptors closely matching the candidate scene feature. The lookup is done as follows. An ordered list is constructed for each qualitative feature component. Suppose there are N qualitative feature components, so there are N ordered lists. The elements of each list are the corresponding elements for all feature descriptors in the model database. Given a feature descriptor from the scene, a binary search is used to locate those values within a range of each qualitative feature component; from these, the matching model features are identified. N sets of model feature identifiers are formed, one for each of the N qualitative feature components. The N sets are then merged to produce a set of candidate pairs, {<f, g>}, where f is a feature from the scene and g is feature in the model database.

For each pair <f, g>, the appearance likelihood is computed and stored in a table M, in the position (f, g). In this table, the scene features form the rows, and the candidate matching model features form the columns. Thus, M(f, g) denotes the appearance likelihood value for matching scene feature f to a model object feature g.

An approximation to the appearance likelihood ratio is computed as:
L(f,g)≈M(f,g)/maxₖM(f,k)
where k comes from a different object than f. A table, L, is constructed holding the appearance likelihood ratio for each pair <f, g> identified above.

An initial alignment of the model with a scene feature is obtained. To do this, the pair <f*, g*> with the maximal value in table L is located. Let O_{g*} be the object model associated with the feature g*. Using the pose associated with f*, X_{f*}, and the pose associated with g*, X_{g}*, an aligning transformation X is computed. The transformation χ places the model into a position and orientation that is consistent with the scene feature; hence, χ is taken as the initial pose of the model.

From the pose χ the set of potentially visible model features of object O_{g*} is computed. These potentially visible model features are now considered to see if they can be matched against the scene. The method is as follows: If a visible model feature k appears in a row j of table M, the geometry likelihood ratio for matching j and k is computed using the previously described approximation method. The appearance likelihood ratio is taken from the table L. The product of the appearance and geometry likelihood ratios of matching j and k is then computed. The product of the appearance and geometry likelihood ratios is then compared to an empirically determined threshold. If this threshold is exceeded, the feature pair <j, k> is considered a match.

If new matches are found, the aligning pose is recomputed including the new feature matches and the process above repeated until no new matches are found. The aligning pose is calculated as follows. Each feature match produces an estimate of the aligning rotation Raᵢ and two three-dimensional feature locations Tgᵢ and Tfᵢ for the model and observed feature respectively. The method seeks to find the rotation R* and translation T* such that Tfᵢ=R^{*}*Tgᵢ+T*. Let Tf′ᵢ and Tg′ᵢ be Tfᵢ and Tgᵢ after subtraction of the mean feature locations of the observed and model features, respectively. Form the matrix M as M=ΣᵢRaᵢ^{T}+Tg′ᵢ*Tf′ᵢ^{T}. The matrix M is now decomposed using SVD as described in Horn's method to produce the rotation R*. Given R* the optimal translation is computed using least squares. These values together form the aligning pose χ.

Finally, the object likelihood ratio is computed using the final value of the pose χ and matched features h. If the object likelihood ratio exceeds τ, the object O is declared present in the image. All scene features (rows of the tables M and L) that are matched are permanently removed from future consideration. If the object likelihood ratio does not exceed this threshold, the initial match between f* and g* is disallowed as an initial match. The process then repeats using the next-best feature match from the table L.

This process continues until all matches between observed features and model features with an appearance likelihood ratio above a match threshold have been considered.

### Second Embodiment

The second embodiment modifies the operation of the first embodiment to perform class-based object recognition. There are other embodiments of this invention that perform class-based recognition and several of these are discussed in the alternative embodiments.

By convention, a class is a set of objects that are grouped together under a single label. For example, several distinct chairs belong to the class of chairs, or many distinct coffee mugs comprise the class of coffee mugs. Class-based recognition offers many advantages over distinct object recognition. For example, a newly encountered coffee mug can be recognized as such even though it has not been seen previously. Likewise, properties of the coffee mug class (e.g. the presence and use of the handle) can be immediately transferred to every new instance of coffee mug.

The second embodiment is described in two parts: database construction and object recognition.

Database Construction

The second embodiment builds on the database of object descriptors constructed as described in the first embodiment. The second embodiment processes a set of model object descriptors to produce a class descriptor comprising:
1) An appearance model consisting of a statistical description of the appearance elements of the pose-invariant feature descriptors of objects belonging to the class;
2) A qualitative model summarizing appearance aspects of the features;
3) A geometry model consisting of a statistical description of geometry elements of the pose-invariant features in a common object reference system, together with statistical information indicating the variability of feature location; and
4) A model of the co-occurrence of appearance features and geometry features. These are each dealt with separately and in turn.
   Constructing a Class Model for Appearance

The second embodiment builds semi-parametric statistical models for the appearance of the pose-invariant features of objects belonging to the class. This process is performed independently on the intensity and range components of the appearance element of a pose-invariant feature.

The statistical model used by the second embodiment is a Gaussian Mixture Model. Each of the Gaussian distributions is referred to as a “cluster”. In such a model, the number of clusters K needs to be chosen. There are various possible methods for making this choice. The second embodiment uses a simple one as described below. Alternative embodiments may choose K according to other techniques.

Assume that there are n specific objects that are to be grouped into a class. Within these n models, consider all features of a given type (the component K of the qualitative feature descriptor). Let Nₖ denote the number of features in the kth object. Let Nₘₐₓ be the max of Nₖ for k=1, . . . n. The second embodiment chooses K to be Nₘₐₓ.

An appearance model with K components is computed to capture the commonly appearing intensity and range properties of the class. It is computed using established methods for statistical data modeling as described in Lu, Hager, and Younes, “A Three-tiered approach to Articulated Object Action Modeling and Recognition”, Neural Information Processing and Systems, Vancouver, B.C. Canada, December 2004. The method operates as follows.

A set of K cluster centers is chosen. This is done in a greedy, i.e. no look-ahead, fashion by randomly choosing an initial feature as a cluster center, and then iteratively choosing additional points that are as far from already chosen points as possible. Once the cluster centers are chosen, the k-means algorithm is applied to adjust the centers. This procedure is repeated several times and the result with the tightest set of clusters in the nearest neighbor sense is taken. That is, for each feature vector fᵢ, the closest (in the sense of Euclidean distance) cluster center cⱼ is chosen. Let dᵢ=∥fᵢ−cⱼ∥. The total penalty for a clustering is the sum of all values dᵢ.

If the number of clusters exceeds the dimension of the feature space, a Gaussian mixture model (GMM) is computed using expectation maximization (EM) using the initial clusters as a starting point. Methods for computing GMMs using EM are described in several standard textbooks on machine learning.

If the number K of clusters is far smaller than the dimensionality of the feature vectors, the modeling step is performed using a combination of linear discriminant analysis (LDA) and modeling as a Gaussian mixture. Given the initial clustering, the within-class and between-class variances are computed. This is processed using linear discriminant analysis to produce a projection matrix Φ. The feature descriptors are projected into a new feature space by multiplying by the matrix Φ.

Given the resulting GMM, the likelihood of any data item i belonging to cluster j can be computed. These weights replace the membership function in the linear discriminant analysis algorithm, a new projection matrix Φ is computed, and the steps above repeated. This iteration is continued to convergence. The result is a final projection matrix Φ* and a set of parameters (Gaussian mean, variance and weight) ⊖ⱼ=<μⱼ, Λⱼ, wⱼ> for each cluster j=1,2, . . . K.

This modeling process is repeated for every type of feature that has been detected in the class. The resulting set of model parameters, GMM_{A}(κ), summarizes all appearance aspects of features of type κ for this class.

Constructing a Class Model for the Qualitative Descriptor

For every appearance feature A, it is now possible to compute the cluster k such that P(A|Φ*, θk) is maximal. Let Fₖ denote the set of all features that are associated with cluster k in this manner. Each of these features has a corresponding qualitative feature descriptor Q. Let Ψₖ denote all qualitative descriptors for feature descriptors in Fₖ.

For every component of the qualitative descriptor, it is now possible to compute the minimum value that descriptor component takes on in Ψₖ as well as the maximum value. Thus, the full range of descriptor values can be represented as a vector of intervals Iₖ bounded by two extremal qualitative descriptors Ψ⁻ₖ and Ψ⁺ₖ.

Any feature that matches well with cluster k is likely to take values in this range. Thus, Iₖ is stored with each cluster as an index.

Constructing a Class Model for Geometry

Finally, a geometric model is computed. Recall that the database in the first embodiment produces a set of pose-invariant features for each model, together with a geometric registration of those features to a common reference frame. The second embodiment preferably makes use of the fact that the model for each member of a class is created starting from a consistent canonical pose. For example, every chair would be facing forward in a canonical model pose, or every coffee mug would have the handle to the side in a canonical model pose.

The first step in developing a class-based geometric model is to normalize for differences in size and scale of the objects in the class. This is performed by the following steps:
1) For each object O of the class C, compute the centroid of the set of 3D feature locations of O. For model features F₁, F₂, . . . Fₙ of the form Fᵢ=<Xᵢ, Qᵢ, Aᵢ>, and Xᵢ=<Tᵢ, Rᵢ> the centroid is
   μ_{O}=(1/n)ΣᵢTᵢ.
2) For each object O of the class C, compute the object scale as
   σ_{O}=sqrt((1/n)Σᵢ∥Tᵢ−μ_{O})∥²)
3) Average the scale values for all objects in the class yielding S_{C}.
4) For each object O of the class, compute the class-relative scale value
   S_{O}=σ_{O}/S_{C}.
5) Compute the mean and standard deviation of s_{O}.

The modeling process is carried out on the geometry component making use of the scale normalization computed above. Consider the set of object features in all the object models that are to be formed into a class C. For each such feature with three-dimensional location T=(x, y, z), normal vector n and centroid μ_{O}=(μx_{O}, μy_{O}, μz_{O}), a new set of values T′=((x−μx_{O})/s_{O}, (y−μy_{O})/sₒ, (z−μz_{O})/s_{O}) is computed. Also, the value o=n^{T}* T′/∥T′∥ is computed to represent the local orientation of the feature. A semi-parametric model for these features is then computed as described above. The resulting geometric model has two components: a Gaussian Mixture Model GMM_{S}(κ) that models the variation in the location and orientation of pose-invariant feature descriptors across the class given a nominal pose and scale normalization, and a distribution P_{S}(s_{O}|C) on the global scale variation within a class C. In this embodiment, the latter is taken to be a Gaussian distribution with mean and variance as computed in step 5 above.

After performing this computation for all feature types, the result is an empirical distribution on the appearance, qualitative characteristics and geometric characteristics of all types of features detected on the objects that are to be members of the class.

Computing the Co-Occurrence of Appearance and Geometry Features

Finally, for all N features detected in the class, the joint statistics on appearance and geometry are computed as follows. Suppose there are u appearance clusters and v geometry clusters. The appearance/geometry co-occurrence table, of size u by v is created as follows. First, the table is initialized with all its entries set to zero.

For each feature, the likelihood of the appearance component is computed separately for all clusters in the Gaussian mixture model. Let i denote the index of an appearance cluster with likelihood aᵢ. Similarly, let j denote the index of a geometry cluster (again making use of the scale normalization described above) with likelihood gⱼ. The entry (i, j) of the table is incremented by aᵢ*gⱼ. This process is repeated for all N pose-invariant features, and the result is normalized by the total of all values in the table to yield a co-occurrence probability P_{co}

Recognition

Given a set of object class models, recognition proceeds as described in the first embodiment with the following modifications.

Let F be the collection of pose-invariant feature descriptors observed in the scene. Define the “class likelihood ratio” as
L_{C}(F,C)=P(F|C)/P(F|˜C)
where P(F|C) is the probability of the feature descriptors F given that an instance of the class is present in the scene and P(F|˜C) is the probability of the feature descriptors F given that the object class is not present in the scene. The class C is considered to be present in the scene if L_{C}(F, C) is greater than a threshold τ. The threshold τ is empirically determined for each class as follows. Several independent images of the class in normally occurring scenes are acquired. For several values of τ, the number of times the class is incorrectly recognized as present when it is not (false positives) and the number of times the class is incorrectly stated as not present when it is (false negatives) is tabulated. The value of τ is taken as that for which the value at which the number of false positives equals the number of false negatives.

Consider a pose-invariant feature descriptor fₖ=<X,Q,A> with X=T,R>. Let a denote an aligning transformation consisting of a pose χ augmented with the dimensionless scale factor s_{O}. The calculation of the likelihood function between fₖ and a model class C with appearance model CA and geometric model CG given an alignment a is
P(fₖ|C,a)=τ_{i,j}P(A|CAᵢ)P(X|CGⱼ,a) P(i,j|C,a)

P(A|CAᵢ) represents the probability that the appearance component is sampled from cluster i of the GMM modeling appearance. The error in observing f is generally far smaller than the variation within the class, so the second embodiment takes the observed scene feature value as having zero variance, which is a reasonable approximation. As a result, the probability value comes directly from the associated Gaussian mixture component for the cluster CAᵢ.

P(X|CGⱼ, a) represents the probability that the feature pose is taken from cluster j of the GMM modeling geometry. It is computed by aligning the observed feature to the model by first transforming the observed features using the pose component χ followed by scaling using the value s_{O}. The resulting scaled translation values correspond to T′ above. The observed value of the local orientation after alignment o is also computed. As before, the second embodiment takes the observed feature value as having zero variance. As a result, the probability value comes directly from the associated Gaussian mixture component for the cluster CGⱼ.

The final probability value P(i,j|C, a) can be computed from the appearance/geometry co-occurrence table computed during the database construction and the probability that the object would appear in the image given the class aligned with transform a, as detailed below.

The cases of interest are those in which an observed scene feature has a well-defined correspondence with an appearance and geometry cluster. For classes, the correspondence hypothesis vector h relates an observed scene feature to a pair of an appearance cluster and a geometry cluster, so that h(k) is the pair [ha(k),hg(k)], where ha(k) is a class appearance cluster and hg(k) is a class geometry cluster.

With this notation, the class likelihood function may be written as

$${L}_{C} ( F , C ) = ( {\sum }_{h} \int aP ( F \vert C , h , a ) P ( h \vert C , a ) P ( a \vert C ) ) / P ( F \vert \sim C )$$

As before, an approximation is given by
L_{C}(F,C)≈maxₐmaxₕP(F|C,h,a)P(h|C,a)P(a|C)/P(F|˜C)
The hypothesis vector h is now an explicit correspondence between an observed feature and a pair consisting of a geometry cluster and an appearance cluster. If the result of this expression exceeds τ, then the object C is deemed present. The value of the aligning transformation a that maximizes this expression specifies the position, orientation, and overall scale of the class instance in the scene.

P(h|C, a) is the probability of the hypothesis h given that the class C is in a given alignment a. It consists of two components: P(h|C, a)=P_{co}(ha|C, hg)*Pₐₚₚ(hg|C,a)

The first term is computed from the geometry co-occurrence table as
P_{co}(ha|C,hg)=⊂ₖP_{co}(ha(k)|C,hg)
with P_{co}(ha(k)|C,hg)=P_{co}(ha(k),hg(k)|C)/ΣᵢP_{co}(i,hg(k)|C).

Pₐₚₚ is an appearance model computed using a binomial distribution based on the number of correspondences in h and the number of geometric clusters that should be detectable in the scene under the alignment a. A geometric cluster is considered to be detectable as follows. Let T represent the mean location of geometric cluster c when the object class is geometrically aligned with the observing camera system (using a). Let μ_{C} denote the location of the origin of the class coordinate system when the object class is geometrically aligned with the observing camera system. Let θ denote the angle the vector T-μ_{C} makes with the optical axis of the camera system. Let o denote the center of the values representing the orientation of the geometric cluster and define α=acos(o). The total angle the geometric cluster makes with the camera optical axis then falls in the range θ−α to θ+α Let θₘₐₓ represent the maximum detection angle for a feature. Then geometric cluster i is considered to be detectable if [θ−α, θ+α]⊂[−θₘₐₓ, θₘₐₓ]).

Applying these refinements yields
L_{C}(F,C)≈maxₐmaxₕP(F|C,h,a)P_{co}(ha|C,hg)Pₐₚₚ(hg|C,a)P(a|C)/P(F|˜C)

Finally, let χ be the pose component of a and let so be the scale value. Then
P(a|C)=P(χ|C)P_{S}(s_{O}|C)
As before, P(χ|C) is taken to be constant, so this expression simplifies to
P(a|C)=P_{S}(s_{O}|C)
Thus, object matching takes into account global scale, and local shape and local appearance characteristics of the object class.

The class-based feature likelihood ratio is now
P(F|C,h,a)/P(F|˜C)=Πₖ L_{A}(F,C,h,k)L_{X}(F,C,h,a,k)
where
L_{A}(F,C,h,k)=P(F_{A}(k)|C_{A}(ha(k)))/P(F_{A}(k)|˜C)
and
L_{X}(F,C,h,a,k)P(Fₓ(k)|Cₓ(hg(k),a))P_{co}(ha(k)|C,hg)/P(Fₓ(k)|˜C)
The former is the class-based appearance likelihood ratio. The latter is the class-based geometry likelihood ratio. The denominators are the class-based appearance likelihood function and geometry likelihood function, respectively. The denominator of the appearance likelihood ratio is approximated as described below. The denominator of the geometry likelihood ratio is taken as a constant value as in the first embodiment.

Class recognition is performed as follows. The first phase is to find smooth connected surfaces, identify interest points and extract a set of scene features, as previously described. The second phase is to match scene features with class models and evaluate the resulting match using the class likelihood ratio. The second phase is accomplished in the following steps.

First, for each observed scene feature, the qualitative feature descriptors are used to look up only those database appearance clusters with qualitative characteristics closely matching the candidate observed feature. Specifically, if a feature descriptor has qualitative descriptor Q, then all appearance clusters k with QεIₖ are returned from the lookup. Let {<f, c>} be the set of feature pairs returned from the lookup on qualitative feature descriptors, where f is a feature observed in the scene and c is a potentially matching model appearance cluster.

For each pair <f, c>, the appearance likelihood is computed and stored in a table M, in position (f, c). In this table, the observed features form the rows, and the candidate model appearance clusters form the columns. Thus M(f, c) denotes the appearance likelihood value for matching observed feature f to a model appearance cluster c.

An approximation to the appearance likelihood ratio is computed as L(f, g)≈M(f, g)/max^{k} M(f, k) where k comes from a different class than g. A table, L, is constructed holding the appearance likelihood ratio for each pair <f, g> identified above.

Next, four or more feature/cluster matches are located that have maximal values of L and belong to the same class model C. For each such matching appearance cluster g, a model geometry cluster k is chosen for which P_{co}(g|C, k) is large. Using the matches, an alignment, a, is computed between the scene and the class model using the feature locations T_{f} and corresponding cluster centers μ_{c}. This alignment is computed by the following steps for n feature/cluster matches:
1) The mean value of the feature locations T_{f} is subtracted from each feature location.
2) The mean value of the cluster centers μ_{c} is subtracted from each cluster center.
3) Let yᵢ represent the location of feature i after mean subtraction. Let xᵢ denote the corresponding cluster center after mean subtraction. Compute the dimensionless scale s=(1/n)Σᵢ∥yᵢ∥/Σᵢ∥xᵢ∥.
4) The rotation is computed using Horn's method. Define M=Σxᵢ*yᵢ^{T} and compute the singular value decomposition U*D*V^{T}=M. Define R=V*U^{T}.
5) Solve for the aligning translation Tₐ as Tₐ=T_{f}−s*R*μ_{c} for a corresponding feature f and cluster c. This is done for all correspondences and the result averaged. Let T be the average.
6) Construct the aligning pose χ from R and T which, together with the dimensionless scale s, defines the aligning transformation a.

For every additional scene feature in the table M and every cluster of the class C, the geometry likelihood ratio is computed using this aligning transformation. The feature likelihood ratio is computed as the product of the appearance likelihood ratio and the geometry likelihood ratio. Let k be the index of a scene feature; let i be the index of an appearance cluster, and j be the index of a geometry cluster such that the feature likelihood ratio exceeds a threshold. Then h(k)=[i, j] is added to the vector h, thereby associating scene feature k with the appearance, geometry pair [i,j].

If new matches are found, the aligning transformation is recomputed including the new geometry feature/cluster matches and the process above repeated until no new matches are found.

The process above is repeated for several choices of geometry clusters associated with the original choice of four matching appearance clusters. The result with the largest feature likelihood ratio is retained.

Finally, the class likelihood ratio is computed. If the class likelihood ratio exceeds τ, the object class C is declared present in the image. All observed scene features that were matched in this process are permanently removed from the tables M and L.

If the object likelihood ratio does not exceed this threshold, a new initial match is chosen by varying at least one of the chosen features. The process then repeats using the new match. This process continues until all matches between observed features and model clusters with an appearance likelihood ratio above a match threshold have been considered.

### Alternative Embodiments and Implementations

The invention has been described above with reference to certain embodiments and implementations. Various alternative embodiments and implementations are set forth below. It will be recognized that the following discussion is intended as illustrative rather than limiting.

Acquiring Range and Intensity Data

In the first and second embodiments, range and co-located image intensity information is acquired by a stereo system, as described above. In alternative embodiments, range and co-located image intensity information may be acquired in a variety of ways.

In some alternative embodiments, a stereo system may be used, but of different implementation. Active lighting may or may not be used. If used, the active lighting may project a 2-dimensional pattern, or a light stripe, or other structure lighting. For the purposes of this invention, it suffices that the stereo system acquires a range image with acceptable density and accuracy.

In other alternative embodiments, the multiple images used for the stereo computation may be obtained by moving one or more cameras. This has the practical advantage that it increases the effective baseline to the distance of camera motion.

In still other alternative embodiments, range and image intensity by be acquired by different sensors and registered to provide co-located range and intensity. For example, range might be acquired by a laser range finder and image intensity by a camera.

The images may be in any part of the electro-magnetic spectrum or may be obtained by combinations of other imaging modalities such as infra-red imaging or ultraviolet imaging, ultra-sound, radar, or lidar.

Locally Transforming Images

In the first and second embodiments, images are locally transformed so they appear as if they were viewed along the surface normal at a fixed distance. In alternative embodiments, other standard orientations or distances could be used. Multiple standard orientations or distances could be used, or the standard orientation and distance may be adapted to the imaging situation or the sampling limitations of the sensing device.

In the first and second embodiments, images are transformed using a second order approximation, as described above. In alternative embodiments, local transformation may be performed in other ways. For example, a first-order approximation could be used, so that the local region is represented as a flat surface. Alternatively, a higher order approximation could be used.

In still other alternatives, the local transformation may be incorporated into interest point detection, or into the computation of feature descriptors. For example, in the first and second embodiments, the image is locally transformed, and then interest points are found by computing the eigenvalues of the gradient image covariance matrix. An alternative embodiment may omit an explicit transformation step and instead compute the eigenvalues of the gradient image covariance matrix as if the image were transformed. One way to do so is to integrate transformation with the computation of the gradient by using the chain rule applied to the composition of the image function and the transformation function. Such techniques, in which the transformation step is incorporated into interest point detection or into feature descriptor computation, are equivalent to a transformation step followed by interest point detection or feature descriptor computation. Hence, when transformation is described, it will be understood that this may be accomplished by a separate step or may be incorporated into other procedures.

Determining Interest Points

In the first and second embodiments, interest points are found by computing the eigenvalues of the gradient image covariance matrix, as described above. In alternative embodiments, interest points may be found by various alternative techniques. Several interest point detectors are described in Mikolajczyk et al, “A Comparison of Affine Region Detectors”, to appear in International Journal of Computer Vision. There are other interest point detectors as well. For such a technique to be suitable, it suffices that points found by a technique be invariant or nearly invariant to substantial changes in rotation about the optical axis and illumination.

In the first and second embodiments, a single technique was described to find interest points. In alternative embodiments, multiple techniques may be applied simultaneously. For example, an alternative embodiment may use both a Harris-style corner detector and a Harris-Laplace interest point detector.

In the first and second embodiments, interest points were computed solely from intensity or from range. In alternative embodiments a combination of both may be used. For example, intensity features located along occluding contours may be detected.

In other alternative embodiments, specialized feature detectors may be employed. For example, feature detectors may be specifically designed to detect written text. Likewise, feature detectors for specialized geometries may be employed, for example a detector for handles.

Alternative embodiments may also employ specialized feature detectors that locate edges. These edges may be located in the intensity component of the 3D image, the range component of the 3D image, or where the intensity and range components are both consistent with an edge.

Locating Interest Points and Transforming the Intensity Image

In the first and second embodiments, the intensity image is transformed before computing interest point locations. This carries a certain computational cost. Alternative embodiments may initially locate interest points in the original image and subsequently transform the neighborhood of the image patch to refine the interest point location and compute the feature descriptor. This speeds up the computation, but may result in less repeatability in interest point detection.

In other alternative embodiments, several interest detectors implicitly constructed to locate features at a specific slant or tilt angle may be constructed. For example, derivatives may be computed at different scales in the x and y directions to account for the slant or tilt of the surface rather than explicitly transforming the surface. Surfaces may be classified into several classes of slant and tilt, and the detector appropriate for that class applied to the image in that region.

In other alternative embodiments, the first phase of interest point detection in the untransformed image may be used as an initial filter. In this case, the neighborhood of the image patch is transformed and the transformed neighborhood is retested for an interest point, possibly with a more discriminative interest point detector. Only those interest points that pass the retest step are accepted. In this way, it may be possible to enhance the selectivity or stability of interest points.

Refining the Location of an Interest Point

In the first and second embodiments, the location of an interest point is computed to the nearest pixel. In alternative embodiments, the location of an interest point may be refined to sub-pixel accuracy. In the general case, interest points are associated with image locations. Typically, this will improve matching because it establishes a localization that is less sensitive to sampling effects and change of viewpoint.

Choosing Interest Points to Reduce the Effects of Clutter

In the first and second embodiments, interest points may be chosen anywhere on an object. In particular, interest points may be chosen on the edge of an object. When this occurs, the appearance about the interest point in an observed scene may not be stable, because different backgrounds may cause the local appearance to change. In alternative embodiments, such unstable interest points may be eliminated in many situations, as follows. From the range data, it is possible to compute range discontinuities, which generally correspond to object discontinuities. Any interest point that lies on a large range discontinuity is eliminated. An alternative embodiment employing this refinement may have interest points that are more stable in cluttered backgrounds.

Determining Local Orientation at an Interest Point

In the first and second embodiments, the local orientation at an interest point is found as described above. In alternative embodiments, the local orientation may be computed by alternative techniques. For example, a histogram may be computed of the values of the gradient orientation and peaks of the histogram used for local orientations.

Standard Viewing Direction

In the first and second embodiments, the local image in the neighborhood of an interest point is transformed so it appears as if it were viewed along the surface normal. In alternative embodiments, the local neighborhood may be transformed so it appears as if it were viewed along some other standard viewing direction.

Feature Descriptors

In the first and second embodiments, each feature descriptor includes a geometric descriptor, an appearance descriptor, and a qualitative descriptor. Alternative embodiments may have feature descriptors with fewer or more elements.

Some alternatives may have no qualitative descriptor; such alternatives omit the initial filtering step during recognition and all the features in the model database are considered as candidate matches. Other alternatives may omit some of the elements in the qualitative features described in the first and second embodiments. Still other alternatives may include additional elements in the qualitative descriptor. Various functions of the appearance descriptor may be advantageously used. For example, the first K components of a principal component analysis may be included. Similarly, a histogram of appearance values in may be included.

Some alternatives may have no geometric descriptor. In such cases, recognition is based on appearance.

Other alternatives may expand the model to include inter-feature relationships. For example, each feature may have associated with it the K distances to the nearest K features or the K angles between the feature normal and the vector to the nearest K features. These relationships are pose-invariant; other pose-invariant relationships between two or more features may be also included in the object model. Such inter-feature relationships may be used in recognition, particularly in the filtering step.

Appearance Descriptors

In the first and second embodiments, the appearance descriptor is the local intensity image and the local range image, each transformed so it appears to be viewed frontally centered. In alternative embodiments, appearance descriptors may be various functions of the local intensity image and local range image. Various functions may be chosen for various purposes such as speed of computation, compactness of storage and the like.

One group of functions is distribution-based appearance descriptors, which use a histogram or equivalent technique to represent appearance as a distribution of values. Another group of functions is spatial-frequency descriptors, which use frequency components. Another group of functions is differential feature descriptors, which use a set of derivatives. Some specific appearance descriptors include steerable filters, differential invariants, complex filters, moment invariants, and SIFT features. Several suitable descriptors are compared in Mikolajczyk and Schmid, “A Performance Evaluation of Local Descriptors”, to appear in IEEE Transactions on Pattern Analysis and Machine Intelligence. Depending on circumstances and application, any of these may be useful in alternative embodiments.

Additionally, appearance descriptors may be explicitly constructed to have special properties desirable for a particular application. For example, appearance descriptors may be constructed to be invariant to rotation about the camera axis. One way of doing this is to use radial histograms. In this case, an appearance descriptor may consist of histograms for each circular ring about an interest point. Specifically, let R be such a ring. Compute two histograms of the values of points in the ring, one for the magnitude of the gradients and one for the angle between the local radial direction and the gradient direction. If each histogram has N_{B} buckets and there are N_{R} rings, then the appearance descriptor has length 2*N_{B}*N_{R}.

There is a very wide diversity of functions that may be used to compute appearance descriptors.

Appearance Descriptors Based on Color Information

In the first and second embodiments, visual appearance is represented using intensity, i.e. gray scale values. Alternative embodiments may use sensors that acquire multiple color bands and use these color bands to represent the visual appearance when computing interest points and/or appearance descriptors. This would be effective in distinguishing objects whose appearance differs only in color.

Appearance Descriptors Based on Geometry

There are additional appearance descriptors based on local geometry information that have the desired invariance properties. One class of such geometry-based appearance descriptors is represented by SPIN images, as described in the paper by Johnson and Hebert, “Using Spin Images for Efficient Object Recognition in Cluttered 3D Scenes” IEEE Transactions on Pattern Analysis and Machine Intelligence, Vol. 21, No. 5, May 1999, pp 433-449.

There are also additional appearance descriptors based on non-local geometry information. An alternative embodiment using these may fit analytic surfaces patches to the range data, growing each patch to be a large as possible consistent with an acceptably good fit to the data. It would classify each surface patch as to quadric type, e.g. plane, elliptic cylinder, elliptic cone, elliptic paraboloid, ellipsoid, etc. Each interest point on a surface would have an appearance descriptor constructed from the surface on which it is found. The descriptor would consist of two levels, lexographically ordered: the quadric type would serve as the first level descriptor, while the parameters of the surface quadric would serve as the second-level descriptor.

Reducing the Dimensionality of the Appearance Descriptors

In the first embodiment, and in several of the alternative embodiments described above, the appearance descriptors have a high dimension. For databases consisting of a very large number of objects, this may be undesirable, since the storage requirements and the search are at least linear in the dimension of the appearance descriptors. Alternative embodiments may reduce the dimensionality of the data. One technique for so doing is principal component analysis, sometimes referred to as the “Karhunen-Loeve transformation”. This and other methods for dimensionality reduction are described in standard texts on pattern classification and machine learning.

In the second embodiment, linear discriminant analysis (LDA) is used to project the appearance descriptors down to a smaller dimension. Alternative embodiments may use other techniques to reduce the dimensionality of the data.

Computing the Object and Class Likelihood Ratios

In the first and second embodiments, the object and class likelihood ratios are approximated by replacing a sum and integral by maximums, as described above. In alternative embodiments, these likelihood ratios may be approximated by considering additional terms. For example, rather than the single maximum, the K elements resulting in the highest probabilities may be used. K may be chosen to mediate between accuracy and computational speed.

The feature likelihood ratio was computed by replacing the denominator with a single value. In alternative embodiments, the K largest likelihood values from an object other than that under consideration may be used. In other alternative embodiments, an approximation to P(f|˜O) may be precomputed from the object database and stored for each feature and object in question.

The first and second embodiments approximate the pose distribution by taking it to be uniform. Alternative embodiments may use models with priors on the distribution of the pose of each object.

Object Database Construction

In the first and second embodiments, the database of object models is constructed from views of the object obtained under controlled conditions. In alternative embodiments, the conditions may be less controlled. There may be other objects in the view or the relative pose on the object in the various views may not be known. In these cases, additional processing may be required to construct the object models. In the case of views with high clutter, it may be necessary to build up the model database piecewise by doing object recognition to locate the object in the view.

Using Discriminative Features in the Database

In the first and second embodiments, all feature descriptors in the database are treated equally. In practice, some feature descriptors are more specific in their discrimination than others. The discriminatory power of a feature descriptor in the database may be computed a variety of ways. For example, it may be computed by comparing each appearance descriptor in the database with every other appearance descriptor; a discriminatory appearance descriptor is one that is dissimilar to the appearance descriptors of all other objects. Alternatively, mutual information may be used to select a set of features descriptors that are collectively selective. The measure of the discriminatory power of a feature descriptor may be used to impose a cut-off such that all features below a threshold are discarded from the model. Alternatively, in some embodiments, the discriminatory power of a feature may be used as a weighting factor.

Models for Classes

In the second embodiment, the database consists of a set of class models. Each class model includes a geometric model, an appearance model, a qualitative model, and a co-occurrence table. Alternative embodiments may have different class models. Some embodiments may have no qualitative model. Other embodiments may have fewer or additional components of the qualitative descriptors of the object models and hence have fewer or additional components in the qualitative class models. Still other embodiments may include inter-feature relationships in the object models and hence have corresponding elements in the class models.

In the second embodiment, a fixed number of classes K were chosen. In alternative embodiments, the number of classes K may be varied. In particular, it is desirable to choose classes that contain features coming from a majority of the objects in a class. To create such a model, it may be desirable to create a model with K clusters, then to remove features that appear in clusters with little support. K can then be reduced and the process repeated until all clusters contain features from a majority of the objects in the class.

In the second embodiment, Euclidean distance was used in the nearest neighbor algorithm. In alternative embodiments, a robust metric such as the L1 norm or an alpha-trimmed mean may be used.

The second embodiment uses a set of largely decoupled models. In particular, a Gaussian Mixture Model is computed for geometry, for the qualitative descriptor, for the image intensity descriptor, and for the range descriptor, as described above. In alternative embodiments some or all of these may be computed jointly. This may be accomplished by concatenating the appearance descriptor and feature location and clustering this joint vector. Alternatively, a decoupled model can be computed and appearance-geometry pairs with high co-occurrence can be associated to each other.

The second embodiment represents the geometry model as a set of distributions of the variation in position of feature descriptors given nominal pose and global scale normalization. Because of the global scale normalization in the class model and in recognition, an object and a scaled version of the object in a scene can be recognized equally well, provided that the scaling is according to the global scale normalization of the class. Alternative embodiments may not model the global scale variation within a class, and in recognition there is no resealing. Consequently, a scaled version of an object will be penalized for its deviation from the nominal size of the class. Depending on the application, either the semantics of the second embodiment or the semantics of an alternative embodiment may be appropriate.

In other embodiments, a wider range of local and global scale and shape models may be used. Instead of a single global scale, different scaling factors may be used along different axes, resulting in a global shape model. For example, affine deformations might be used as a global shape model. Also, the object may be segmented into parts, and a separate shape model constructed for each part. For example, a human figure may be segmented into the rigid limb structures, and a shape model for each structure developed independently.

The second embodiment builds scale models using equal weighting of the features. However, if some feature clusters contain more features and/or have smaller variance, alternative embodiments may weight those features more highly when computing the local and global shape models.

The second embodiment performs recognition by computing the class likelihood ratio based on probability models computed from the feature descriptors of objects belonging to a class. Alternative embodiments may represent a class by other means. For example, a support vector machine may be used to learn the properties of a class from the feature descriptors of objects belonging to a class. Alternatively, many other machine-learning techniques described in the literature may be used to learn the properties of a class from the feature descriptors of objects belonging to a class and may be used in this invention to recognize class instances.

Class Database Construction

The second embodiment computes class models by independently normalizing the size of each object in the class, and then computing geometry clusters for all size-normalized features. In alternative embodiments, object models may be matched to each other, subject to a group of global deformations, and clustering performed when all class members have been registered to a common frame. This may be accomplished by first clustering on feature appearance. The features of each object that are associated with a particular cluster may be taken to be potential correspondences among models. For any pair of objects, these correspondences may be sampled using a procedure such as RANSAC to produce an aligning transformation that provided maximal agreement among the features of the models.

Sharing Features Among Classes

The second embodiment constructs a separate model for each class; in particular, the clusters of one class are not linked to the clusters of another. Alternative embodiments may construct class models that share features. This may speed up database construction, since class models for previously encountered features may be re-used when processing a new class. It may also speed-up recognition, since a shared feature is represented once in the database, rather than multiple times.

Filtering Matches in Recognition

In the first embodiment, the attempt to match an observed feature to the model database is made faster by using the qualitative descriptor as a filter and by using multiple binary searches to implement the lookup. Alternative embodiments may do the lookup in a different way. Various data structures might be used in place of the ordered lists described in the first embodiment. Various data structures that can efficiently locate nearest neighbors in a multi-dimensional space may be used.

Recognition—Obtaining an Initial Alignment

The first embodiment obtains an initial alignment of the model with a portion of the scene by using a single correspondence <f*, g*> as described above. Alternative embodiments may obtain an initial alignment is other ways.

One alternative is to replace the single correspondence <f*, g*> with multiple corresponding points <f₁, g₁>, . . . , <f_{N}, g_{N}> where all the model features gk belong to the same object. The latter approach may provide a better approximation to the correct aligning pose if all the fₖ are associated with the same object in the scene. In particular, if N is at least 3, then the alignment may be computed using only the position components, which may be advantageous if the surface normals are more noisy than the position.

Another alternative is to replace the table L with a different mechanism for choosing correspondences. Correspondences may be chosen at random or according to some probability distribution. Alternatively, a probability distribution could be constructed from M or L and the RANSAC method may be employed, sampling from possible feature correspondences. Also, groups of correspondences <f₁, g₁>, . . . , <f_{N}, g_{N}> may be chosen so that the fₖ are in a nearby region of the observed scene, so as to improve the chance than all the fₖ are associated with the same object in the scene. Alternatively, distance in the scene may be used as a weighing function for choosing the fₖ. There are many variations on these ideas.

Similar considerations apply to class recognition. There are many ways of choosing correspondences to obtain an initial alignment of the class model with a portion of the scene. An example will illustrate the diversity of possible techniques. When choosing the correspondences <f₁, g₁>, . . . , <f₄, g₄> described in the second embodiment, it is desirable that all the fₖ are associated with the same object in the scene. One means for insuring this is to extract smooth connected surfaces from the range data, as described as one possible embodiment in the section “Locally Transforming Images”. Each interest point may then be associated with the surface on which it is found. In typical situations, each surface so extracted lies on only one object of the scene, so that the collection of interest points on a surface belong to the same object. This association may be used to choose correspondences so that all the fₖ are associated with the same object.

Recognition When the Object Likelihood Ratio Does Not Exceed the Threshold

In the first embodiment, if the object likelihood ratio does not exceed the threshold, the initial match between f* and g* is disallowed as an initial match. In alternative embodiments, the initial match may be disallowed only temporarily and other matches considered. If there are disallowed matches and an object is recognized subsequent to the match being disallowed, the match is reallowed and the recognition process repeated. This alternative embodiment may improve detection of objects that are partially occluded. In particular, the computation of P(h|O, χ) can take into account recognized objects that may occlude O. This may increase the likelihood ratio for the object O when occluding objects are recognized.

Decision Criteria

The first and second embodiments compute probabilities and approximations to probabilities; they base the decision as to whether an object or class instance is present in an observed scene using an approximation to the likelihood ratio. In alternative embodiments, the computation may be performed without considering explicit probabilities. For example, rather than compute the probability of an observed scene feature f given an model object feature or model class feature g, an alternative embodiment may simply compute a match score between f and g. Various match score functions may be used. Similar considerations apply to matches between groups of scene features F and model or class features G. The decision as to whether an object or class instance is present in an observed scene may be based on the value of a match score compared to empirically obtained criteria and these criteria may vary from object to object and from class to class.

Hierarchical Recognition

The first embodiment recognizes specific objects; the second embodiment recognizes classes of objects. In alternative embodiments, these may be combined to enhance recognition performance. That is, an object in the scene may first be classified by class, and subsequent recognition may consider only objects within that class. In other embodiments, there may be a hierarchy of classes, and recognition may proceed by starting with the most general class structure and progressing to the most specific.

Implementation of Procedural Steps

The procedural steps of the several embodiments have been described above. These steps may be implemented in a variety of progranming languages, such as C++, C, Java, Ada, Fortran, or any other general-purpose programming language. These implementations may be compiled into the machine language of a particular computer or they may be interpreted. They may also be implemented in the assembly language or the machine language of a particular computer. The method may be implemented on a computer, and executing program instructions may be stored on a computer-readable medium.

The procedural steps may also be implemented in specialized programmable processors. Examples of such specialized hardware include digital signal processors (DSPs), graphics processors (GPUs), media processors, and streaming processors.

The procedural steps may also be implemented in electronic hardware designed for this task. In particular, integrated circuits may be used. Examples of integrated circuit technologies that may be used include Field Programmable Gate Arrays (FPGAs), gate arrays, standard cells, and full custom ICs.

Implementation using any of the methods described in this invention disclosure may carry out some of the procedural steps in parallel rather than serially.

Application to Robotics

Among other applications, this invention may be applied to robotic manipulation. Objects may be recognized as described in this invention. Once an object has been recognized, properties relevant to robotic manipulation can be looked up in a database. These properties include its surface(s), its weight, and the coefficient of friction of its surface(s).

Application to Face Recognition

Among other applications, this invention may be applied to face recognition. Prior techniques for face recognition have used either appearance models or 3D models, or have combined their results only after separate recognition operations. By acquiring registered range intensity images, by constructing models based on pose-invariant features, and by using them for recognition as described above, face recognition may be performed advantageously.

Other Applications

The invention is not limited to the applications listed above. The present invention can also be applied in many other fields such as inspection, assembly, and logistics. It will be recognized that this list is intended as illustrative rather than limiting and the invention can be utilized for varied purposes.

### CONCLUSION, RAMIFICATIONS AND SCOPE

In summary, the invention disclosed herein provides a system and method for performing 3D object recognition using range and appearance data.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

1. A method of choosing pose-invariant interest points on a three-dimensional (3D) image, comprising the steps of
transforming the intensity image at a plurality of image locations so that the local region about each image location appears approximately as it would appear if it were viewed in a standard pose with respect to a camera; and
applying one or more interest point operators to the transformed image.

2. The method of claim 1 wherein the step of transforming the image is performed by using the range data to compute the standard pose with respect to the camera.

3. The method of claim 2 wherein the standard pose is such that the image appears as if it were viewed with the camera axis along the surface normal.

4. The method of claim 1 wherein the step of transforming the image further comprises the steps of:
computing a second-order approximation to the local surface geometry from the range data of the 3D image; and
warping the image according to the second-order approximation.

5. The method of claim 2, wherein the step of transforming the image further comprises the steps of:
using the range data to compute the surface normal at each image location; and
using the surface normal and the range data to compute the standard pose with respect to the camera.

6. A method of computing pose-invariant feature descriptors of a three-dimensional (3D) image, comprising the steps of
choosing one or more interest points on the intensity image;
transforming the intensity image so that the local region about each interest point appears approximately as it would appear if it were viewed in a standard pose with respect to a camera; and
computing a feature descriptor comprising a function of the intensity image in the local region about each interest point in the transformed image.

7. The method of claim 6 wherein the step of transforming the image is performed by using the range data to compute the standard pose with respect to the camera.

8. The method of claim 7, wherein the step of transforming the image further comprises the steps of:
using the range data to compute the surface normal at each interest point; and
using the surface normal and the range data to compute the standard pose with respect to the camera.

9. The method of claim 7 wherein the standard pose is such that the image appears as if it were viewed with the camera axis along the surface normal.

10. The method of claim 6 wherein the step of transforming the image further comprises the steps of:
computing a second-order approximation to the local surface geometry from the range data of the 3D image; and
warping the image according to the second-order approximation.

11. The method of 6 wherein the feature descriptor further comprises a function of the local range image as it would appear if it were viewed in a standard pose with respect to the camera.

12. The method of 6 wherein the feature descriptor further comprises a function of the 3D pose of the interest point.

13. The method of 6 wherein the feature descriptor further comprises a function of the 3D pose of one or more other interest points of the image.

14. The method of 6 wherein the step of computing a feature descriptor further comprises computing a dimensionality reduction in the function of the local region.

15. A method for recognizing objects in an observed scene, comprising the steps of
acquiring a three-dimensional (3D) image of the scene;
choosing pose-invariant interest points by applying one or more interest point operators to the intensity component of the image as it would appear if it were viewed in a standard pose with respect to a camera.
computing pose-invariant feature descriptors of the intensity image at the interest points,
constructing a database comprising 3D object models, each object model comprising a set of pose-invariant feature descriptors of one or more images of an object; and
comparing the pose-invariant feature descriptors of the scene image to pose-invariant feature descriptors of the object models.

16. A method for recognizing objects in an observed scene, comprising the steps of
acquiring a three-dimensional (3D) image of the scene;
choosing pose-invariant interest points in the image;
computing pose-invariant feature descriptors of the image at the interest points, each feature descriptor comprising a function of the local intensity component of the 3D image as it would appear if it were viewed in a standard pose with respect to a camera;
constructing a database comprising 3D object models, each object model comprising a set of pose-invariant feature descriptors of one or more images of an object; and
comparing the pose-invariant feature descriptors of the scene image to pose-invariant feature descriptors of the object models.

17. The method of claim 15 wherein the step of comparing the pose-invariant feature descriptors is performed by evaluating the probability that feature descriptors of the scene are the result of observing feature descriptors of the object models.

18. The method of claim 17 wherein the step of evaluating the probability that feature descriptors of the scene are the result of observing feature descriptors of the object models further comprises the steps of:
computing a correspondence of feature descriptors in the scene with feature descriptors of an object model and an alignment under that correspondence,
evaluating an approximation to the likelihood ratio under the correspondence and alignment.

19. The method of claim 18 wherein the step of computing a correspondence and alignment further comprises the steps of
computing a correspondence of a small number of feature descriptors;
computing an alignment based on the small number of feature descriptors; and
iteratively performing the sub-steps of:
identifying potentially visible model features using the alignment;
retaining those visible model features that match feature descriptors in the scene;
updating the correspondence to include the retained model features; and
updating the current alignment based on the retained model features.

20. A method for computing three-dimensional (3D) class models, comprising the steps of
acquiring 3D images of objects with class labels;
choosing pose-invariant interest points in the images by applying one or more interest point operators to the intensity component of the images as they would appear if viewed in a standard pose with respect to a camera;
computing pose-invariant object feature descriptors at the interest points; and
computing functions of the pose-invariant object feature descriptors and the class labels.

21. A method for computing three-dimensional (3D) class models, comprising the steps of
acquiring 3D images of objects with class labels;
choosing pose-invariant interest points in the images;
computing pose-invariant feature descriptors at the interest points, each feature descriptor comprising a function of the local intensity component of the 3D image as it would appear if it were viewed in a standard pose with respect to a camera; and
computing functions of the pose-invariant feature descriptors and the class labels.

22. The method of claim 20 wherein the step of computing functions further comprises computing Gaussian Mixture Models over the feature descriptors, each Gaussian Mixture Model comprising one or more clusters.

23. The method of claim 22 wherein the step of computing functions further comprises computing Gaussian Mixture Models of the global size variation within the class.

24. The method of claim 20 wherein the step of computing functions further comprises computing one or more support vector machines.

25. A method for recognizing instances of classes in an observed scene, comprising the steps of:
acquiring a three-dimensional (3D) image of a scene;
choosing pose-invariant interest points in the image by applying one or more interest point operators to the intensity component of the image as it would appear if it were viewed in a standard pose with respect to a camera;
computing pose-invariant feature descriptors at the interest points;
constructing a database comprising 3D class models; and
comparing pose-invariant feature descriptors of the scene image to the 3D class models.

26. The method of claim 25 wherein the 3D class models comprise Gaussian Mixture Models, each Gaussian Mixture Model comprising one or more clusters.

27. The method of claim 25 wherein the step of comparing the pose-invariant feature descriptors to the 3D class models further comprises evaluating the probability that feature descriptors of the scene are the result of observing clusters of a class model.

28. The method of claim 27 wherein the step of evaluating the probability that feature descriptors of the scene are the result of observing clusters of a class model further comprises the steps of:
computing a correspondence of feature descriptors in the scene with clusters of a class model and an alignment under that correspondence; and
evaluating an approximation to the likelihood ratio under the correspondence and alignment.

29. A method for recognizing instances of classes in an observed scene, comprising the steps of:
acquiring a three-dimensional (3D) image of a scene;
choosing pose-invariant interest points in the image;
computing pose-invariant feature descriptors at the interest points, each feature descriptor comprising a function of the local intensity component of the 3D image as it would appear if it were viewed in a standard pose with respect to a camera;
constructing a database comprising 3D class models; and
comparing pose-invariant feature descriptors of the scene image to the 3D class models.
